(19) United States
(12) Patent Application Publication
(10) Pub. No.: US 2004/0064470 A1
(43) Pub. Date: Apr. 1, 2004

(54) Method for generating a stand-alone multi-user application from predefined spreadsheet logic

(75) Inventor: Kristian Raue, Freiburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Jedox GmbH, Freiburg (DE)

(21) Appl. No.: 10/633,221

(22) Filed: Aug. 1, 2003

Related U.S. Application Data
(60) Provisional application No. 60/400,838, filed on Aug. 2, 2002.

(51) Int. Cl. G06F 17/00

(52) U.S. Cl. 707/100

(57) ABSTRACT

In a method for generating a stand-alone multi-user application from a user-defined spreadsheet logic, the user-defined spreadsheet logic is analyzed and at least one source code module is derived from the analyzed user-defined application logic. The resulting application runs independently from the original spreadsheet and offers functionality for integrating multiple users and multiple report entities over a network, such as the Internet.

Priority is claimed to provisional patent application 60/400,838, the subject matter of which is hereby incorporated by reference herein.

### BACKGROUND

By inputting values and formulas in industry-type spreadsheets, the everyday PC user can easily model a wide spectrum of calculation and application logic within minutes. Trying to implement the same kind of functionality by using a programming language (Java, PHP, Visual Basic, etc.) usually results in longer implementation cycles and also requires programmer skills. As a result of this, spreadsheets are considered a valuable advance in office productivity.

On the other side programming languages offer a lot of flexibility, for example in respect to multi-user support, database storage, data consolidation and accessibility over a network, such as the internet, intranet and/or a client-server network.

### SUMMARY OF THE INVENTION

The invention provides a method for generating a stand-alone multi-user application. The method comprises analyzing a predefined spreadsheet logic, and deriving at least one source code module from the analyzed predefined spreadsheet logic.

The invention further provides storing results of the analyzing of the user-defined spreadsheet logic in an application metafile, and deriving at least one source code module from the application metafile. Moreover, the invention further provides generating an application frame configured to operate on a user input using the at least one source code module and the application metafile so as to generate an output in accordance with the user-defined spreadsheet logic.

In an embodiment the invention provides a method for operating a spreadsheet. The method includes: analyzing a user-defined application logic of the spreadsheet; deriving at least one source code module from the analyzed user-defined application logic; and generating an application frame configured to operate on a user input using the at least one source code module; and accessing the application frame by a first and a second user so as to generate an output in accordance with the user-defined application logic.

In another embodiment the invention provides a stand-alone multi-user application. The stand-alone user application includes an application metafile including results of an analyzing of a user-defined spreadsheet logic, and at least one source code module derived from the application metafile.

In yet another embodiment the invention provides a computer readable medium having stored thereon computer executable process steps operative to perform a method for generating a stand-alone multi-user application. The method includes analyzing a predefined spreadsheet logic, and deriving at least one source code module from the analyzed predefined spreadsheet logic.

The invention provides the ability to extract application logic from a predefined, for example by a user, spreadsheet and generate code for a programming language. With the generated code it is possible to automatically produce a stand-alone application, i.e., an application that works independently from the original spreadsheet while preserving the user-defined application logic from the spreadsheet. Since the application logic now becomes accessible in programming code, additional features like multi-user support, centralized database storage, data consolidation and accessibility over a network, such as the internet, an intranet or a client/server network, can be added.

Multi-user support means that the number of users that simultaneously work on one spreadsheet can be greater than one. All users can work on the same common data set or each user works on his own data set.

Centralized database storage means that all data from all users is stored in one centralized data storage as opposed to storing single spreadsheets for each user on local PCs. Centralized data storage also means that the data can easily be saved for backup and can easily be used for extensive database queries over all users.

Data Consolidation means that data can be split into reporting entities and then grouped into a hierarchal consolidation tree which allows level-based aggregation of the data. It is also possible to aggregate data by users or user groups.

Network accessibility means that the application can be accessed through a network, such as the internet, and that the data is also transferred over the network.

This extended functionality removes major disadvantages in the way spreadsheets are used today. With the invention it is now possible to distribute spreadsheets applications instantaneously over a network to many users and multiple report entities and additionally have the ability to store, consolidate and query all data centrally.

The present invention advantageously combines advantages of spreadsheet based modeling with the features that become available when using programming languages.

### BRIEF DESCRIPTION OF THE DRAWINGS

FIG. 1 shows an overview flowchart of a method for generating a stand-alone multi-user application from a user-defined spreadsheet to the resulting software application.

FIG. 2 shows a sample spreadsheet that is used in the application of FIG. 1.

FIG. 3 and FIG. 4 show a flowchart of detailed steps of the “analyze the user defined spreadsheet logic and store the logic in an Application Metafile” step of the flowchart of FIG. 1.

FIG. 5 indicates the different cell types in the sample spreadsheet of FIG. 2.

FIG. 6 shows a Layout Description Code (in HTML) for the sample spreadsheet of FIG. 2.

FIG. 7a shows the Application Metafile (in XML) for the sample spreadsheet of FIG. 2.

FIG. 7b shows a detail of part of the Application Metafile of FIG. 7a.

FIG. 8, FIG. 9 and FIG. 10 show a flowchart of detailed steps of the “produce Source Code Modules from the Application Metafile” step of FIG. 1.

FIG. 11a shows generated source code for setting constant values in the application of FIG. 1.

FIG. 11b shows generated source code for receiving user input values in the application of FIG. 1.

FIG. 11c shows generated source code for loading values from a database.

FIG. 11d shows generated source code for saving values to a database.

FIG. 11e shows generated source code for calculating calculated values in the application of FIG. 1.

FIG. 12 shows a flowchart of detailed steps of the “run Application Frame and call previously generated Source Code Modules and outputs the result to the output device” step of FIG. 1.

FIG. 13 shows a screenshot of the resulting software application of FIG. 1.

### DETAILED DESCRIPTION

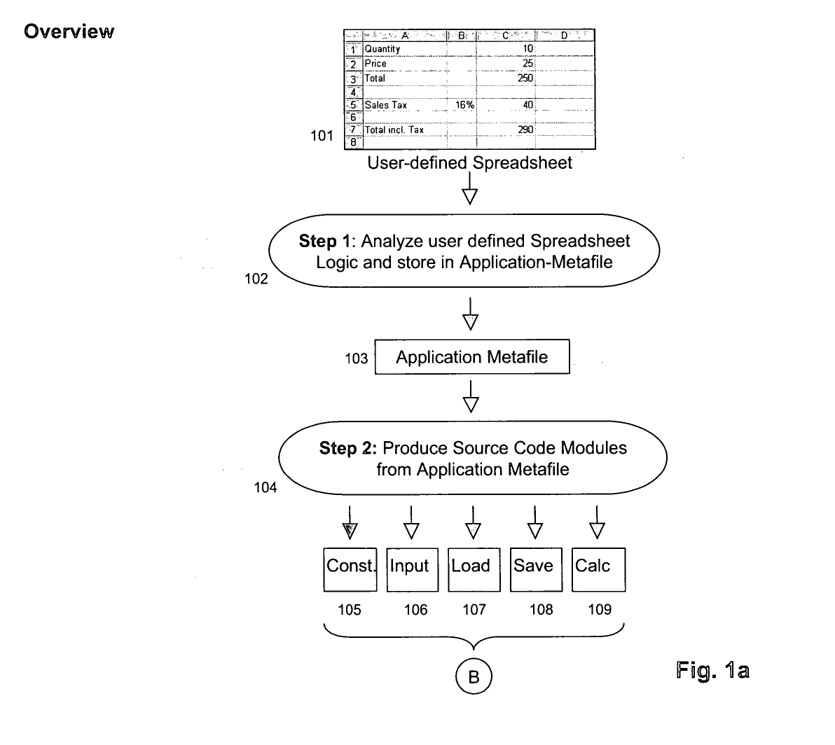

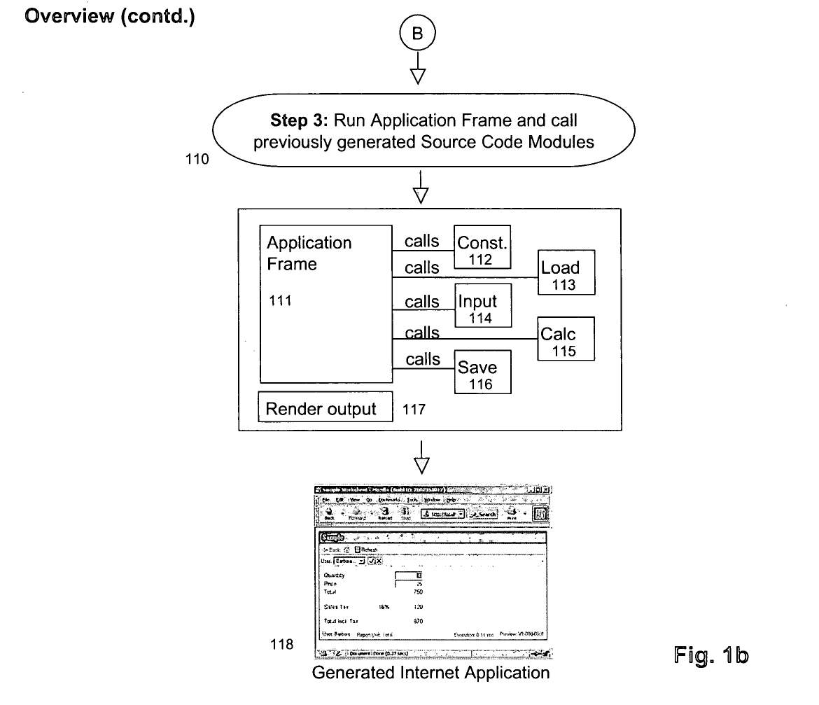

Using the application logic of a spreadsheet as a building plan for automatically generating a stand-alone multi-user application involves three basics steps according to the present invention, as shown in the overview in FIG. 1a and FIG. 1b. In the embodiment described, the resulting application is an internet application, i.e., accessible over the internet.

For demonstration purposes a simple spreadsheet application is used. In other embodiments complex spreadsheets can be used but the principle way of conversion is the same and works both for simple and for complex spreadsheet applications.

As FIG. 1a shows as a first step [102] the spreadsheet [101] with the user defined application logic is analyzed. Relevant information of the spreadsheet application is then saved into a structured Application Metafile [103]. This Application Metafile basically serves as the building plan for the future application.

In the second step [104] the information from the Application Metafile is then used to generate code modules for a programming language (for example PHP, Java, Visual basic, etc.). For each of the basic operations of an application (Defining Constants [105], Input [106], Saving [107], Loading [108], Calculating [109]) a separate code module is generated.

FIG. 1b shows the third step [110]. A standardized Application Frame [111] is executed. The Application Frame initializes the session, authenticates the user and establishes a connection to the data storage. In order to process the application logic the previously generated code modules are called from the Application Frame.

The Application Frame first calls module ‘Const.’ [112] to set the constant values. Then the Application Frame calls module ‘Load’ [113] to load data that has been previously stored. Then the Application Frame calls module ‘Input’ [114] to handle all input that might have been entered by the user. Then the Application Frame calls module ‘Calc’ [115] to calculate all calculated values. Finally module ‘Save’ [116] is called to save the data to the data storage.

The last action in the third step on FIG. 1b is the rendering process [117] which outputs the values to screen [118].

Step 1 is now explained in more detail. Steps 2 and 3 are explained in detail below.

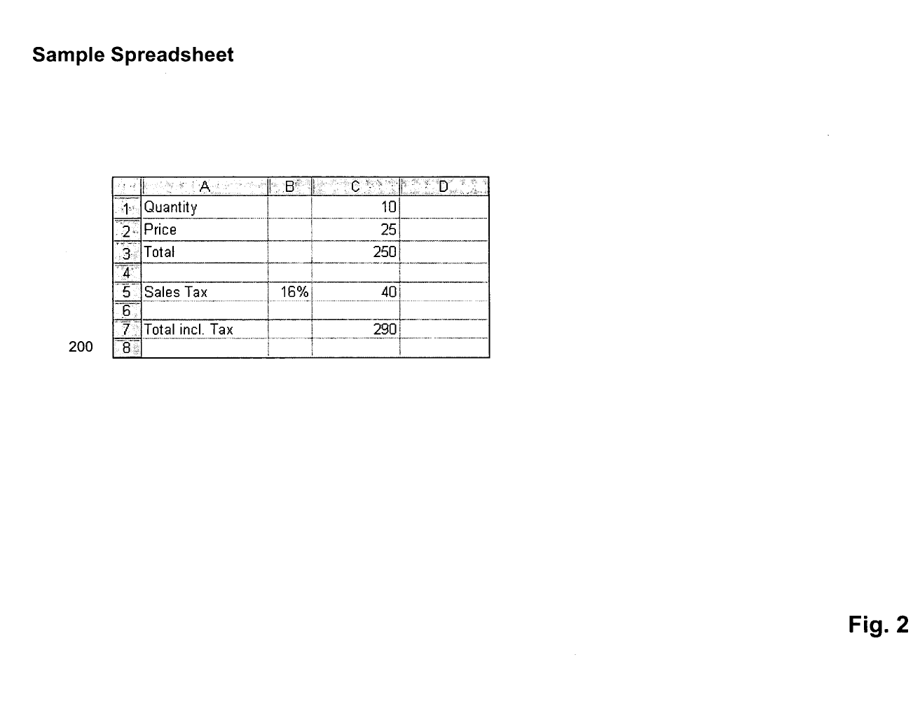

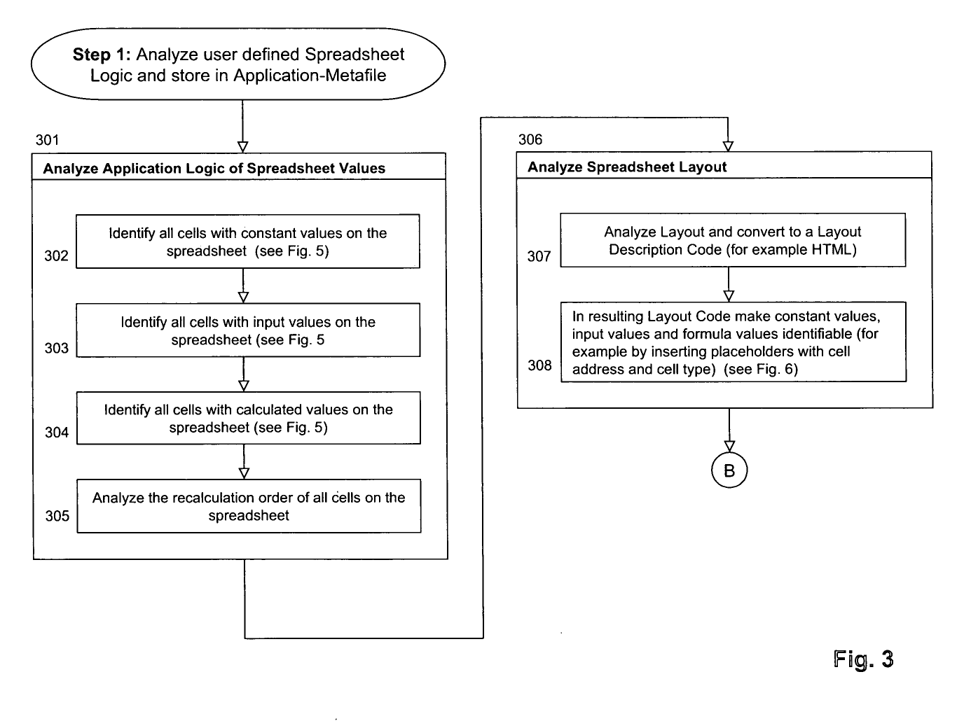

FIG. 3 explains the detailed actions for analyzing the user defined Spreadsheet Logic. First the Application Logic of all Spreadsheet Values is analyzed [301].

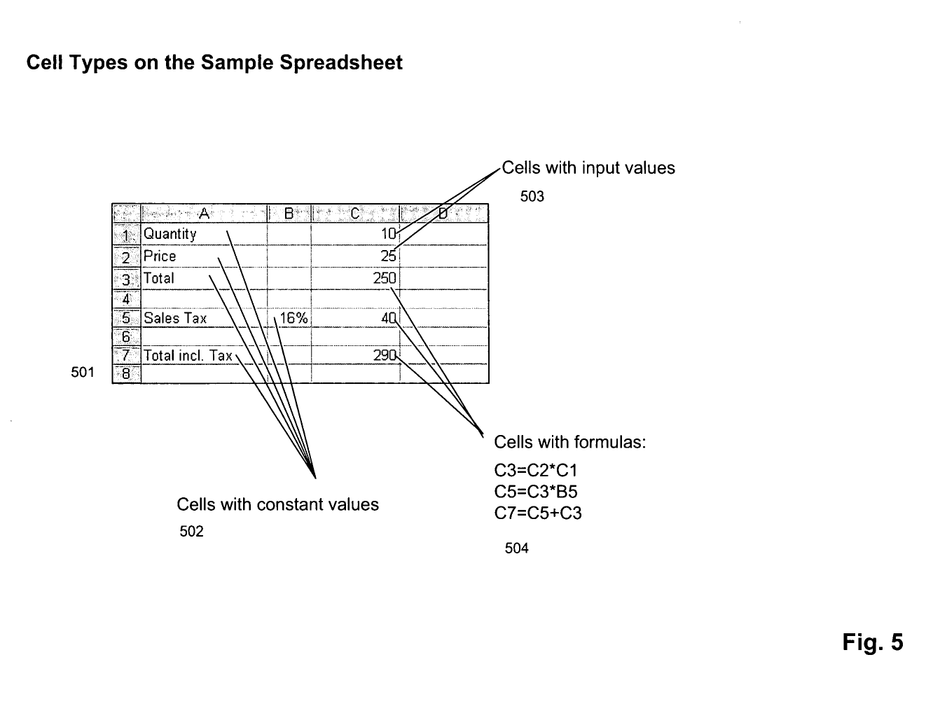

FIG. 5 shows the different types of values on the sample spreadsheet [501]. On the sample spreadsheet cells with constant cells [502], cells with input values [503] and cells with calculated values (formulas) can be found.

Back in FIG. 3 as the first action all constant values on the spreadsheet are found [302]. This is achieved by walking through all cells on the spreadsheet and adding those cells to a list that do contain a value and do not contain a formula and do have cell protection switch on.

Then all input values are found [303]. This is achieved by walking through all cells on the spreadsheet and adding those cells to a list that do contain a value and do not contain a formula and do not have cell protection switch on.

Then all calculated values are found [304]. This is achieved by walking through all cells on the spreadsheet and adding those cells to a list that do contain a formula.

If there is more than one formula on a spreadsheet, the recalculation order matters. Hence it is necessary to find the natural order in which the calculated cells must be calculated in order to get the expected result [305]. Natural order means that one cell formula may only be calculated if all the references cells in the formula have already been calculated.

Finding the natural recalculation order is a standard problem in information technology. For example can the natural recalculation order of cells be found by analyzing the cell formula of each cell and finding its predecessors. If all predecessors of the calculated cell are not calculated cells then this calculated cell can be put at the beginning of the calculation order and can temporarily be marked as not being a calculated cell. Otherwise it is pushed at the end list of the cells to be analyzed. Then the predecessors of the next calculated cell in the list are checked in the same matter. If all predecessors of this calculated cell are not calculated cells it is put on second position on the calculation order and is temporarily marked as not being a calculated cell, otherwise the cell is added at the end of the list of the cells to be analyzed. This sequence is repeated until all calculated cells are marked as temporarily not a calculated cell.

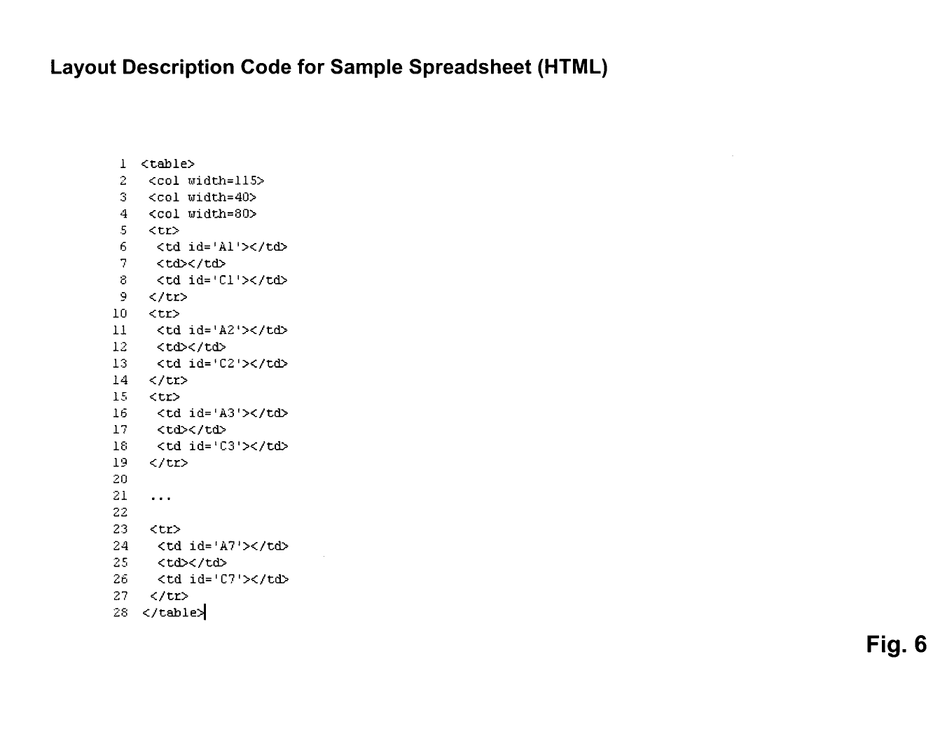

After the logic of the spreadsheet values is analyzed the spreadsheet layout is analyzed and brought into a format that can later be used to reestablish the original layout [306]. A way to achieve this is to use a Layout Description Code like Postscript or HTML. All cells of the spreadsheet grid are converted in corresponding codes in the Layout Description Code [307]. Instead of adding the current values of the cells into the Layout Description Code identifiable placeholders (like ID=‘C1’) are generated and integrated at the corresponding position in the layout Description Code [308]. Later it is then possible to replace the placeholders with the actual values computer by the future application. FIG. 6 shows the HTML Code for the sample spreadsheet with the placeholders in position.

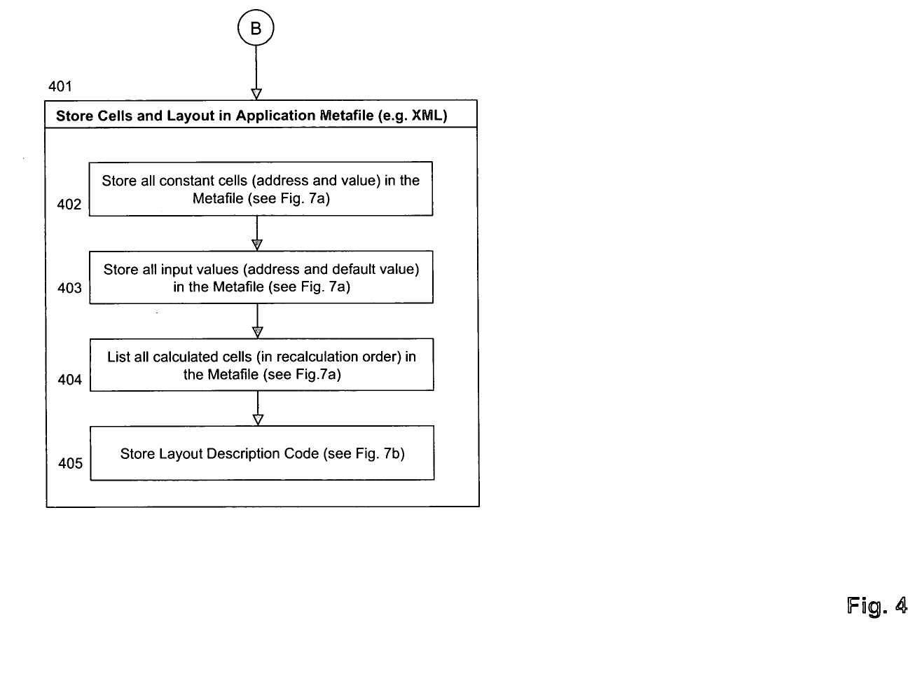

FIG. 4 explains the detailed actions for completing the analyzing of the user defined Spreadsheet Logic. The results of the cell type analysis and the result of the Layout Analysis is stored in a structured file called Application Metafile [401].

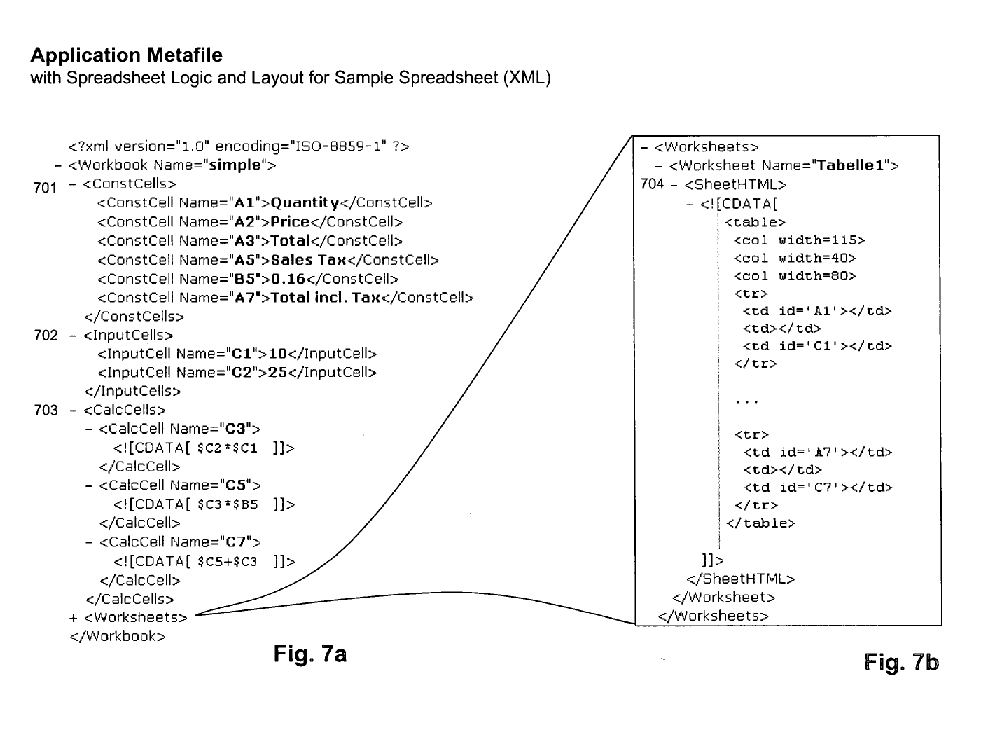

All constant cells and their value are stored as a list in the Application Metafile [402]. The way this is done in an embodiment for the sample spreadsheet using the widely accepted XML format is illustrated in FIG. 7a under section ConstCells [701]. Instead of XML, a proprietary format of any suitable kind could be used, as long as the format allows to store data and data structures of any kind. XML is widely accepted as an easily understandable format.

Then all input cells and their default value are stored as a list in the Application Metafile [403]. The way this can be done for the sample spreadsheet using the XML format is illustrated in FIG. 7a under section InputCells [702].

Then all calculated cells and their formula are stored in natural order in the Application Metafile [404]. The way this can be done for the sample spreadsheet using the XML format is illustrated in FIG. 7a under section CalcCells [703].

Finally the Layout Description Code also is stored in the Application Metafile [405]. The way this can be done for the sample spreadsheet using the HTML and XML format is illustrated in FIG. 7b under section SheetHTML [704].

This ends the detailed description of Step 1. Now Step 2 is explained in more detail.

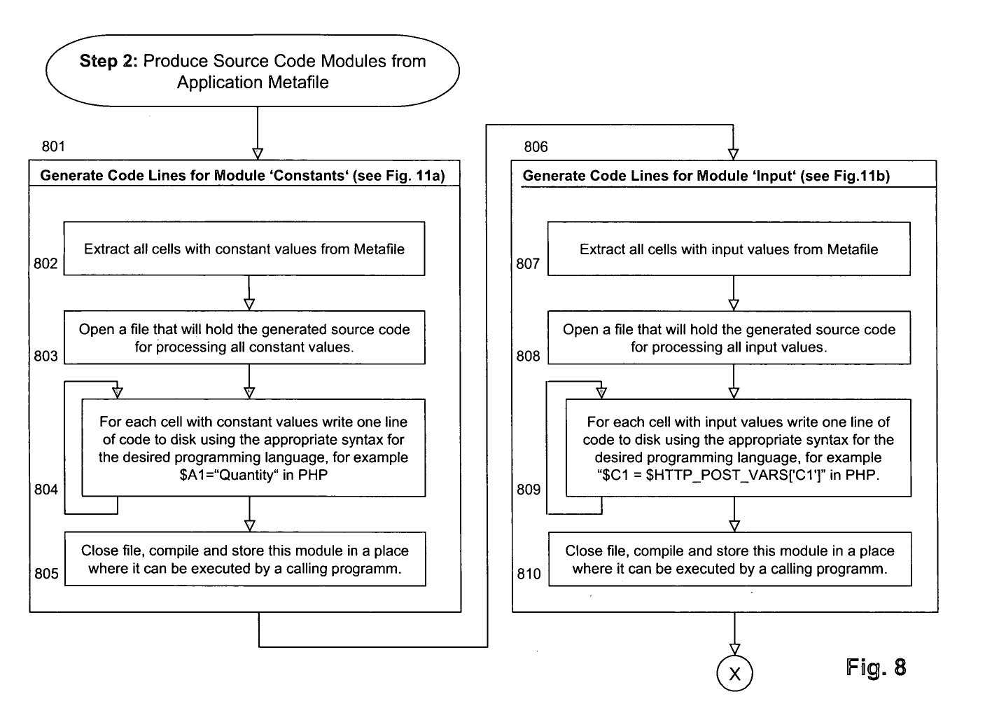

FIG. 8, FIG. 9 and FIG. 10 explain how the building plan in the Application Metafile is used to generate the fundamental Code Modules for the resulting stand-alone software application.

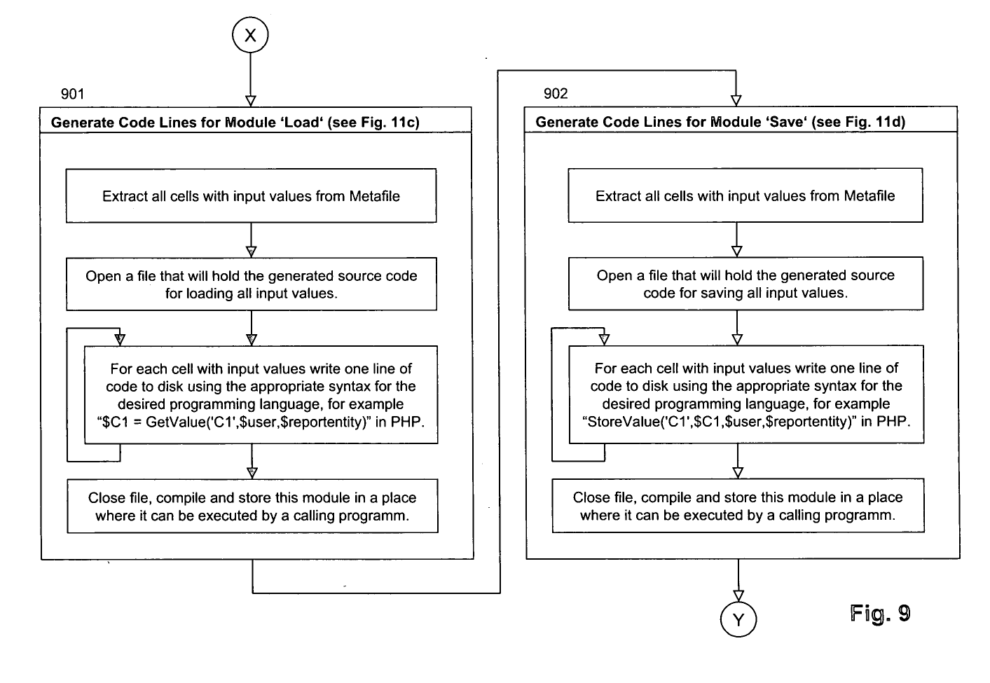

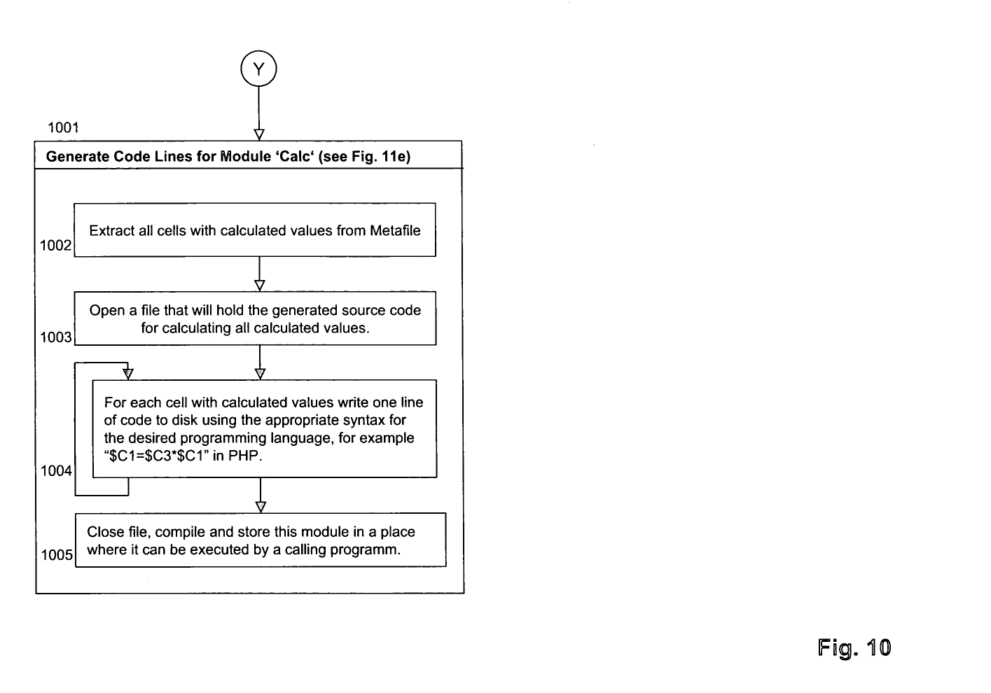

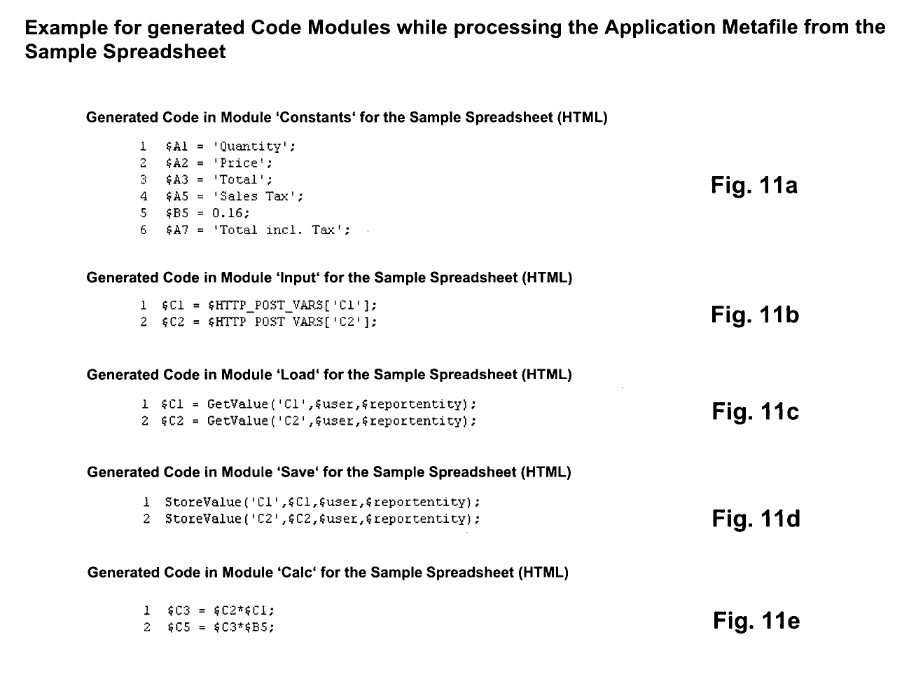

In the first action in Step 2 the code module for setting constant values is generated from the Application Metafile [801]. The list of constant cell values is extracted from the Metafile [802] and a new source code file is opened for this module [803]. For each constant cell in the Application Metafile one line of code is generated [804]. For the sample spreadsheet this might result in a code line like “$A1=”Quantity;”. This code could be executed by the programming language PHP. If the future application is supposed to run in a different programming language the code might look slightly different. Finally the code module is saved under the name ‘Constants’, then compiled and stored in a place where it can be called or executed as subroutine by the future application [805]. The complete code generated for the sample spreadsheet is shown in FIG. 11a.

In other embodiments of the present invention, another programming language besides PHP may be used. Virtually an language is acceptable that can be used to create Internet-, Intranet- or Client/Server-Applications. These include, but are not limited to, Java, Javascript, JavaServerPages (JSP uses Java internally), Visual Script, Visual Basic, Active Server Pages (ASP uses Visual Script or Javascript internally), C, C++, etc.)

The above procedure is then applied to all Input Cells in the Metafile [806]. The list of input cells is extracted from the Metafile [807] and a new source code file is opened for this module [808]. For each constant cell in the Application Metafile one line of code is generated [809]. For the sample spreadsheet this might result in a code line like “$C1=$HTTP_POST_VARS[‘C1’];”. This line of code accepts an input value from the user and stores it in the appropriate variable. This code could be executed by the programming language PHP. If the future application is supposed to run in a different programming language the code might look slightly different. Finally the code module is saved under the name ‘Input, then compiled and stored in a place where it can be called or executed as subroutine by the resulting application [810]. The complete code generated for the sample spreadsheet is shown in FIG. 11b.

The above procedure is repeated two more times for all Input Cells in the Application Metafile as shown in FIG. 9 [901], [902]. The only difference to the first processing of the Input Cells is the fact that the modules are named “Load” and “Save” and that the possibly generated code syntax is “$C1=GetValue(‘C1’,$user,$reportentity)” (Module Load) or “StoreValue(‘C1’,$C1,$user,$reportentity)” (Module Save). The newly generated code modules will be later called by the future application to load values for a specific user and a specific report entity from the data storage or save values for a specific user and a specific report entity in the data storage. The complete code generated for the sample spreadsheet is shown in FIG. 11c and FIG. 11d.

The above procedure is then applied one more time to all calculated cells in the Application Metafile [1001]. The list of calculated cells is extracted from the Metafile [1002] and a new source code file is opened for this module [1003]. For each calculated cell in the Application Metafile one line of code is generated [1004]. For the sample spreadsheet this might result in a code line like “$C1=$C3*$C1;”. This code could be executed by the programming language PHP. If the future application is supposed to run in a different programming language the code might look slightly different. Finally the code module is saved under the name ‘Calc, then compiled and stored in a place where it can be called or executed as subroutine by the future application [1005]. The complete code generated for the sample spreadsheet is shown in FIG. 11e.

This ends the detailed description of Step 2. Now Step 3 is explained in more detail.

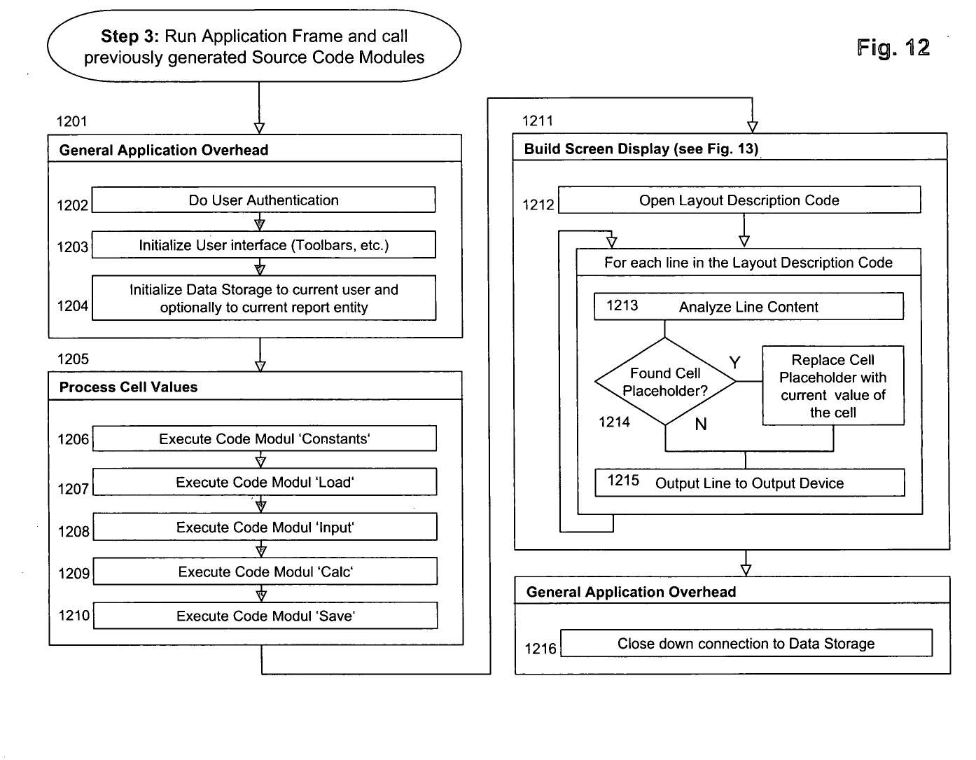

FIG. 12 shows in that the resulting application basically consists of four sections which integrate the previously generated code modules and also use the stored layout code to produce screen output.

The first section contains general application overhead which is common to many Internet Applications [1201]. First the current user is identified and authenticated [1202]. Then the user interface (window frames, toolbars and a status bar) is generated [1203]. Finally the connection to the data storage for the current user and the current report entity is established [1204].

The next section is an important section because in this section most of the individual application logic from the former spreadsheet is processed [1205]. Since the actual application logic resides in the previously generated code modules these modules are sequentially executed now. First Code Module ‘Constants’ is called to set all constant values [1206]. Then Code Module ‘Load’ is called to load User Data that was entered in previous sessions [1207]. Then Code Module ‘Input’ is called to handle all user input [1208]. With all constant values and all Input values in memory Code Module ‘Calc’ is executed to calculate all values [1209]. Finally Code Module ‘Save’ is executed which stores all user data to the corresponding location in the data storage [1210].

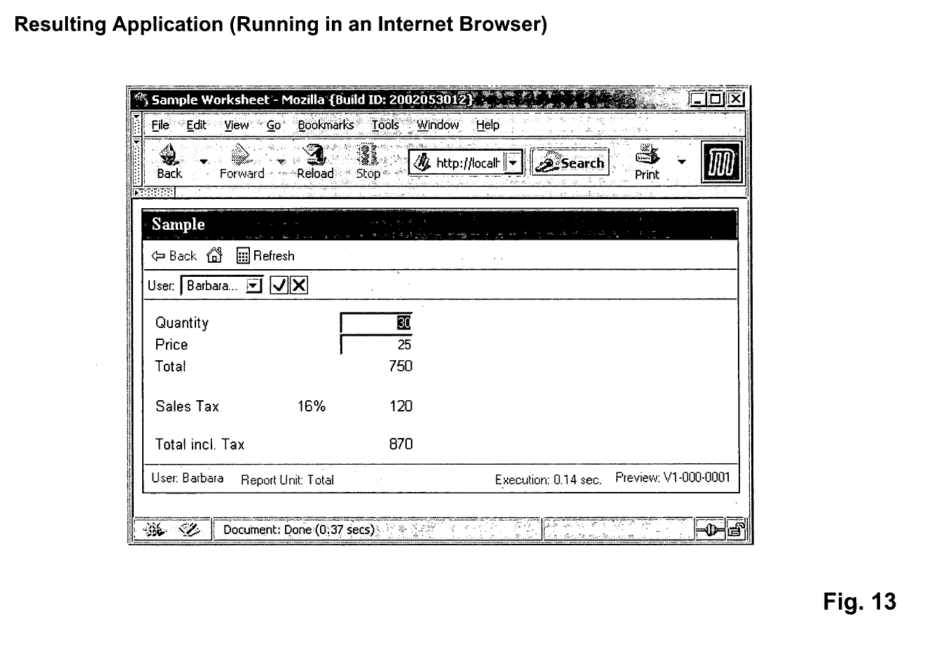

The third section merges the actual application values with the screen layout that is stored in the Layout Description Code [1212]. The Layout Description code is processed line by line. Each line of the Layout Description Code is scanned for a placeholder that was inserted when the Layout Description Code was derived from the original spreadsheet [1213]. If a placeholder is found, it is replaced by the current value was it was processed in the previous section [1214]. Each processed line of layout code is then forwarded to the output device (for example to an Internet Browser using the HTTP Protocol) [1215]. The screen output for the application that was derived from the sample spreadsheet is shown in FIG. 13.

In the last section the connection to the data storage is terminated and the session is terminated [1216] as shown in FIG. 12.

The standalone application can reside on any suitable hardware that is able to serve as a webserver and is capable of running at least one of the mentioned programming languages. Examples include server hardware manufactured by Intel, AMD, IBM, SUN, Compay, HP, etc. The client (user-access) application can reside on any hardware that is able to run a internet/intranet browser or an other suitable client software. Examples include a PC or Workstation manufactured by Intel, AMD, IBM, SUN, Macintosh, Compaq, HP, etc.

What is claimed is:

1. A method for generating a stand-alone multi-user application, comprising:
analyzing a predefined spreadsheet logic; and
deriving at least one source code module from the analyzed predefined spreadsheet logic.

2. The method as recited in claim 1 wherein the deriving is performed by:
storing results of the analyzing of the user-defined spreadsheet logic in an application metafile; and
deriving at least one source code module from the application metafile.

3. The method as recited in claim 1 further comprising generating an application frame configured to operate on a user input using the at least one source code module and the application metafile so as to generate an output in accordance with the user-defined spreadsheet logic.

4. The method as recited in claim 3 wherein the application frame is configured to accept inputs from multiple users substantially simultaneously and to operate on the inputs using the at least one source code module and the application metafile so as to generate an output in accordance with the user-defined spreadsheet logic.

5. The method as recited in claim 3 wherein the application frame is configured to store data associated with the multiple users in a central database.

6. The method as recited in claim 3 wherein the application frame is configured to split data associated with the multiple users into reporting entities and grouping the data in a hierarchal consolidation tree so as to enable at least one of level-based, user-based and user group-based aggregation of the data.

7. A method for operating a spreadsheet comprising:
analyzing a user-defined application logic of the spreadsheet;
deriving at least one source code module from the analyzed user-defined application logic; and
generating an application frame configured to operate on a user input using the at least one source code module; and
accessing the application frame by a first and a second user so as to generate an output in accordance with the user-defined application logic.

8. The method as recited in claim 7 wherein the accessing is performed by the first and second users accessing the application frame substantially simultaneously.

9. The method as recited in claim 7 further comprising storing data associated with the first and second users in a central database.

10. The method as recited in claim 7 further comprising splitting data associated with the first and second users into reporting entities and grouping the data in a hierarchal consolidation tree so as to enable at least one of level-based, user-based and user group-based aggregation of the data.

11. The method as recited in claim 7 wherein the accessing is performed via a network.

12. A stand-alone multi-user application comprising:
an application metafile including results of an analyzing of a user-defined spreadsheet logic; and
at least one source code module derived from the application metafile.

13. The stand-alone multi-user application as recited in claim 12 further comprising an application frame configured to operate on a user input using the at least one source code module and the application metafile so as to generate an output in accordance with the user-defined spreadsheet logic.

14. The stand-alone multi-user application as recited in claim 13 wherein the application frame is configured to accept inputs from multiple users substantially simultaneously and to operate on the inputs using the at least one source code module and the application metafile so as to generate an output in accordance with the user-defined spreadsheet logic.

15. The stand-alone multi-user application as recited in claim 14 wherein the application frame is configured to store data associated with the multiple users in a central database.

16. The stand-alone multi-user application as recited in claim 14 wherein the application frame is configured to split data associated with the mulitple users into reporting entities and group the data in a hierarchal consolidation tree so as to enable at least one of level-based, user-based and user group-based aggregation of the data.

17. A computer readable medium having stored thereon computer executable process steps operative to perform a method for generating a stand-alone multi-user application, the method comprising:
analyzing a predefined spreadsheet logic; and
deriving at least one source code module from the analyzed predefined spreadsheet logic.

18. The computer-readable medium as recited in claim 17 wherein the deriving is performed by:
storing results of the analyzing of the user-defined spreadsheet logic in an application metafile; and
deriving at least one source code module from the application metafile.

19. The computer-readable medium as recited in claim 18 wherein the method further comprises generating an application frame configured to operate on a user input using the at least one source code module and the application metafile so as to generate an output in accordance with the user-defined spreadsheet logic.
